(19) United States
(12) Patent Application Publication
(10) Pub. No.: US 2021/0312356 A1
(43) Pub. Date: Oct. 7, 2021

(54) AUTONOMOUS TRAVEL VEHICLE AND TRAFFIC SYSTEM

(71) Applicants: TOYOTA JIDOSHA KABUSHIKI KAISHA, Toyota-shi (JP); DENSO CORPORATION, Kariya-city (JP)

(72) Inventors: Hiroshi Higashide, Toyota-shi (JP); Kenji Okazaki, Toyota-shi (JP); Keiichi Uno, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 17/194,560

(22) Filed: Mar. 8, 2021

(30) Foreign Application Priority Data
Apr. 2, 2020 (JP) 2020-066647

(51) Int. Cl. G06Q 10/06; G05D 1/02; G05D 1/00; B60W 60/00

(52) U.S. Cl. CPC G06Q 10/06311; G05D 1/0212; G01C 21/343; B60W 60/0053; G05D 1/0061

(57) ABSTRACT

After an evacuating drive for moving a vehicle to an evacuation destination station is performed subsequent to receipt of an operation interruption command, upon receiving an operation restart command while at the evacuation destination station, an operation schedule modifier executes a schedule modification so that, based on an actual operation delay duration with respect to an operation schedule, a travel duration for traveling from the evacuation destination station to an operation schedule updating site is shortened as compared to a corresponding travel duration according to the operation schedule.

### CROSS REFERENCE TO RELATED APPLICATION

This application claims priority to Japanese Patent Application No. 2020-066647 filed on Apr. 2, 2020, which is incorporated herein by reference in its entirety including the specification, claims, drawings, and abstract.

### TECHNICAL FIELD

The present specification discloses an autonomous travel vehicle that travels in a circulation route along which a plurality of stations are provided, and a traffic system comprising such autonomous travel vehicles and an operation management device for the vehicles.

### BACKGROUND

In recent years, traffic systems using vehicles capable of autonomous travel are being proposed. For example, JP 2000-264210 A discloses a vehicle traffic system using vehicles capable of performing autonomous travel along an exclusive route. This vehicle traffic system comprises a plurality of vehicles that travel along an exclusive route, and a supervising control system that causes the plurality of vehicles to perform operation. The supervising control system transmits a start command, a travel path command, and the like to the vehicles in accordance with an operation plan. Further, the supervising control system increases or decreases the number of vehicles according to demand for riding the vehicles.

Here, there may be cases in which the operation is temporarily interrupted, such as at times of disorders in the traffic system and VIP movements. In such cases, when the operation is subsequently restarted, a delay is generated with respect to a preset operation schedule. In view of this, the present specification discloses an autonomous travel vehicle and a traffic system that enable prompt elimination of a delay generated in association with an operation interruption.

### SUMMARY

The present specification discloses an autonomous travel vehicle that travels in a circulation route along which a plurality of stations are provided. The autonomous travel vehicle comprises an operation schedule storage section, an autonomous travel controller, a drive mode switching controller, and an operation schedule modifier. The operation schedule storage section has stored therein an operation schedule for one cycle of the circulation route, the operation schedule having been supplied at an operation schedule updating site set up along the circulation route. The autonomous travel controller carries out an autonomous travel control based on the operation schedule, and executes an emergency stop control upon receipt of an operation interruption command. After performance of an evacuating drive for moving the vehicle to an evacuation destination station subsequent to the receipt of the operation interruption command, upon receiving an operation restart command while at the evacuation destination station, the operation schedule modifier executes a schedule modification so that, based on an actual operation delay duration with respect to the operation schedule, a travel duration for traveling from the evacuation destination station to the operation schedule updating site is shortened as compared to a corresponding travel duration according to the operation schedule.

According to the above configuration, when an operation interruption command is issued, the vehicle is made to wait at an evacuation destination station until restart of operation, so that a part of the operation interruption duration can be absorbed into the boarding/alighting duration at the station. Furthermore, after restart of operation, the delay can be eliminated by modifying and shortening the operation schedule.

In the above configuration, the autonomous travel vehicle may comprise: a display unit that, upon receipt of the operation interruption command, displays to an on-board administrator an image requesting execution of manual driving; and an input unit via which a command for executing manual driving can be input. The autonomous travel vehicle may further comprise a drive mode switching controller that, when the command for executing manual driving is input, switches from autonomous travel driving by the autonomous travel controller to manual driving by the on-board administrator in carrying out the evacuating drive.

According to the above configuration, it is possible to persuade the on-board administrator to execute manual driving at the time of an evacuating drive.

The present specification also discloses a traffic system comprising autonomous travel vehicles according to the above configuration, and an operation management device for managing operation of the autonomous travel vehicles. The operation management device comprises an operation schedule creator, an operation schedule supplier, and a command unit. The operation schedule creator creates the operation schedule for the plurality of autonomous travel vehicles. The operation schedule supplier supplies the operation schedule for one cycle of the circulation route to each autonomous travel vehicle when the vehicle is passing the operation schedule updating site. The command unit is able to issue an operation interruption command and an operation restart command to the plurality of autonomous travel vehicles. As the operation schedule, the operation schedule creator creates a normal operation schedule set such that operation intervals between the plurality of autonomous travel vehicles become uniform. Further, for an autonomous travel vehicle whose time of passage of the operation schedule updating site subsequent to restart of operation is predicted to be delayed from a target time of passage according to the normal operation schedule, the operation schedule creator creates, as the operation schedule for a next cycle, a recovering operation schedule in which a cycle travel duration is shortened in accordance with a delay duration as compared to the normal operation schedule.

According to the above configuration, when a delay cannot be fully eliminated during the travel to the operation schedule updating site after restart of operation, it is possible to continue to eliminate the delay during the next cycle.

According to the technology disclosed in the present specification, a delay generated accompanying an operation interruption can be eliminated promptly.

### BRIEF DESCRIPTION OF DRAWINGS

Embodiment(s) of the present disclosure will be described based on the following figures, wherein:

FIG. 1 is a schematic diagram showing a traffic system comprising autonomous travel vehicles and an operation management device according to an embodiment;

FIG. 2 is a hardware configuration diagram of the operation management device and an autonomous travel vehicle;

FIG. 3 is a functional block diagram of the operation management device and the autonomous travel vehicle;

FIG. 4 is a diagram (1 of 2) explaining terms used in connection with creation of an operation schedule;

FIG. 5 is a diagram (2 of 2) explaining terms used in connection with creation of an operation schedule;

FIG. 6 is a timetable graph showing an example normal operation schedule;

FIG. 7 is a partially enlarged view of a timetable graph according to a normal operation schedule;

FIG. 8 is a timetable graph illustrating an example operation management performed upon issuance of an operation interruption command;

FIG. 9 is a flowchart illustrating an example evacuation control performed upon receipt of the operation interruption command;

FIG. 10 is a partially enlarged view of FIG. 8, showing a timetable graph mainly illustrating an example operation of the autonomous travel vehicles from operation interruption until restart of operation;

FIG. 11 is a flowchart illustrating an example recovering control performed upon receipt of an operation restart command;

FIG. 12 is a partially enlarged view of FIG. 8, showing a timetable graph mainly illustrating an example operation of the autonomous travel vehicles after the restart of operation;

FIG. 13 is a flowchart illustrating an example process of creating a recovering operation schedule; and

FIG. 14 is a partially enlarged view of FIG. 8, showing a timetable graph mainly illustrating an example timeline regarding supplying of a recovering operation schedule.

### DESCRIPTION OF EMBODIMENTS

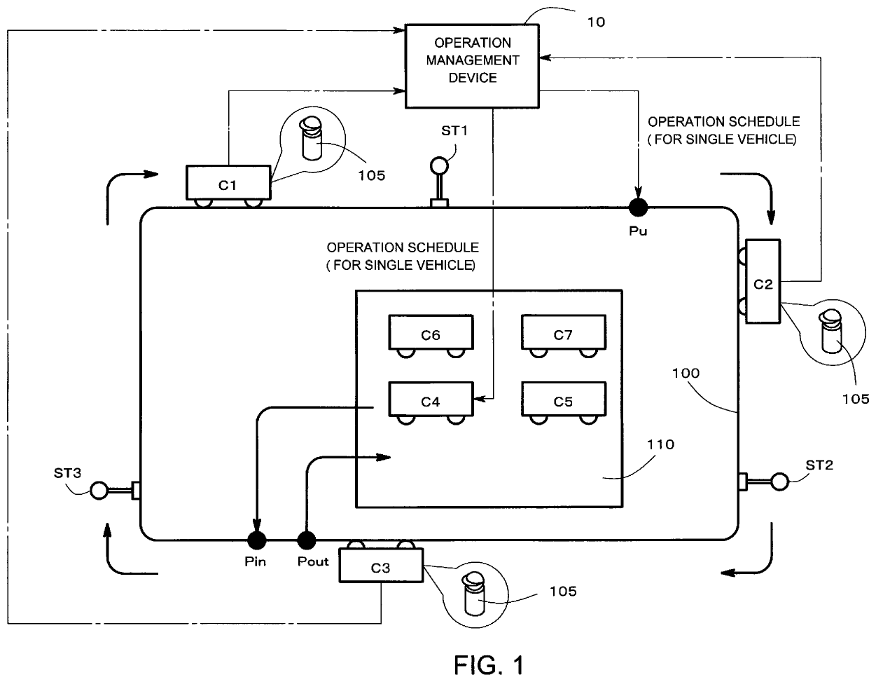

FIG. 1 shows, as an example, a schematic diagram of a traffic system comprising autonomous travel vehicles C1-C7 and an operation management device 10 according to an embodiment. In this traffic system, a plurality of stations ST1-ST3 are provided along a circulation route 100.

In the following, when the plurality of autonomous travel vehicles C1-C7 are to be referred to without being distinguished from each other, the distinguishing suffix numeral is omitted to indicate “vehicle(s) C”. Similarly, when the plurality of stations ST1-ST3 do not need to be distinguished from each other, an indication “station(s) ST” is used.

In the traffic system illustrate in FIG. 1, the vehicles C travel along the predefined circulation route 100, and a large number of general public users are transported. The vehicles C travel along the circulation route 100 in a circulating manner by one-way traffic as denoted by arrows shown in the figure, and stop by the stations ST1-ST3 provided along the circulation route 100.

The circulation route 100 may be, for example, an exclusive road on which only the vehicles C are permitted to travel. When the vehicles C are railroad vehicles, the circulation route 100 may be a circulation rail line. Alternatively, the circulation route 100 may be a route designated on general roads on which vehicles other than the vehicles C are also permitted to travel.

The traffic system further comprises a vehicle depot 110 connecting to the circulation route 100. As an example, FIG. 1 shows the autonomous travel vehicles C4-C7 on standby in the vehicle depot 110. On the circulation route 100, a retrieving point Pout and an adding point Pin are provided as points of connection to the vehicle depot 110. In the example of FIG. 1, the retrieving point Pout and the adding point Pin are located between the station ST2 and the station ST3.

The autonomous travel vehicles C1-C3 traveling along the circulation route 100 enter the vehicle depot 110 via the retrieving point Pout. The autonomous travel vehicles C4-C7 on standby in the vehicle depot 110 are added into the circulation route 100 from the adding point Pin. In order to avoid the vehicles C to be retrieved and the vehicles C to be added from getting in each other's way, the retrieving point Pout is arranged upstream of the adding point Pin.

The circulation route 100 further comprises an operation schedule updating point Pu (operation schedule updating site) at which the operating autonomous travel vehicles C1˜C3 are supplied with their respective operation schedules. At the operation schedule updating point Pu, to each vehicle C passing the point Pu, an operation schedule for one cycle of the circulation route 100 starting from the operation schedule updating point Pu is supplied from the operation management device 10. In this way, every time the vehicle C passes the operation schedule updating point Pu (i.e., for every cycle), the operation schedule is changed. The method of supplying the operation schedule is described in detail further below.

### <Vehicle Configuration>

The vehicles C are vehicles capable of performing autonomous travel along the circulation route 100, and function as, for example, public transportation vehicles for transporting a large number of general public users from a predetermined station ST to another station ST. For example, the vehicles C may be public transportation buses.

Each vehicle C is a vehicle capable of autonomous travel. For example, drive control belonging to level 3 according to the standards defined by the Society of Automotive Engineers (SAE) in the U.S. is possible. That is, the vehicle C may be capable of performing a drive control in which drive manipulations on the circulation route 100 are automated while manual driving is carried out by an administrator 105 in the event of emergency. For example, as explained further below, when an operation interruption command is issued to the operating autonomous travel vehicles C, autonomous travel control is interrupted. Subsequently, manual driving is performed in moving each vehicle C to an evacuation destination station. In order to enable such manual driving, an administrator 105 is aboard each operating vehicle C.

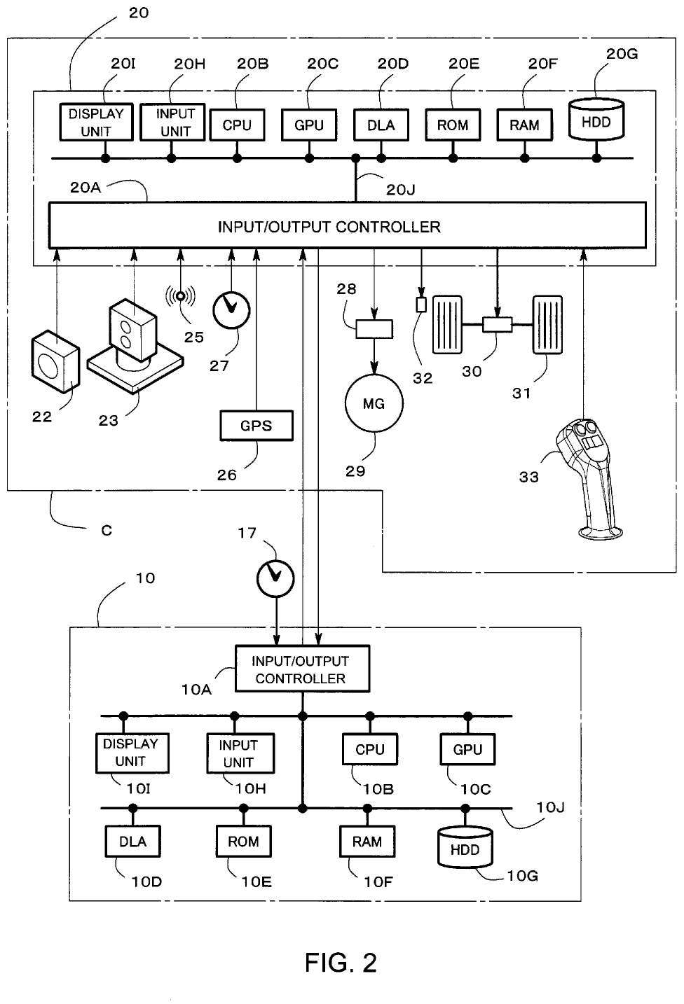

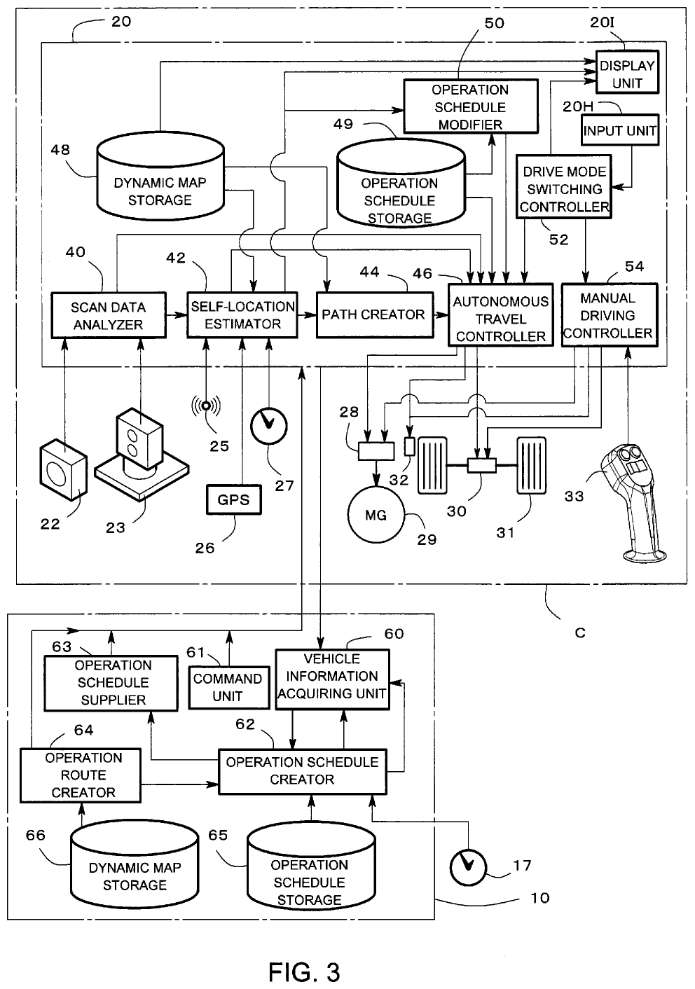

FIG. 2 illustrates example hardware configurations of the vehicle C and the operation management device 10. Further, FIG. 3 illustrates example functional blocks of the vehicle C and the operation management device 10, shown together with hardware components. As illustrated for example in FIGS. 2 and 3, the vehicle C is an electric vehicle having a rotating electric machine 29 (motor) as a drive source and including a battery (not shown) as an electric power source. The vehicle C can communicate (i.e., can perform exchange of data) with the operation management device 10 via wireless communication.

The vehicle C is further equipped with mechanisms that enable autonomous travel. Specifically, the vehicle C comprises a control unit 20, a camera 22, a LiDAR unit 23, a proximity sensor 25, a GPS receiver 26, a clock 27, a drive mechanism 28, a steering mechanism 30, a braking mechanism 32, and a manipulation lever 33.

The camera 22 captures images in a field of view that is substantially identical to that of the LiDAR unit 23. The camera 22 comprises an image sensor such as a CMOS sensor or a CCD sensor. The images captured by the camera 22 (captured images) are used for autonomous travel control, as described further below.

The LiDAR unit 23 is a sensor for autonomous travel, and may be, for example, a distance-measuring sensor using infrared radiation. For example, an infrared laser beam is emitted from the LiDAR unit 23 to scan in the horizontal and vertical directions, and it is thereby possible to acquire three-dimensional point cloud data in which measured distance data regarding the surroundings of the vehicle C are arranged three-dimensionally. The camera 22 and the LiDAR unit 23 are provided as one sensor unit, and this sensor unit is located, for example, on each of four faces of the vehicle C; namely, the front face, the rear face, and the two lateral faces connecting between the front and rear faces.

The proximity sensor 25 may be a sonar sensor, and when, for example, the vehicle C is to stop at a station ST, the proximity sensor 25 detects a distance between the vehicle C and a road curb marking a border between a roadway and a sidewalk. By means of this detection, so-called precise docking control is enabled, which is a control for stopping the vehicle C closely along the road curb. The proximity sensor 25 is, for example, mounted on the vehicle C on the two lateral faces and at corner portions between the front face and the lateral faces.

The GPS receiver 26 receives measured location signals from GPS satellites. For example, by receiving the measured location signals, the current location (latitude and longitude) of the vehicle C can be calculated.

As a mechanism for performing manual driving, the vehicle C comprises the manipulation lever 33. For example, the manipulation lever 33 is provided in a front part of the vehicle cabin of the vehicle C. For example, the manipulation lever 33 can be tilted toward the front, rear, left, and right, and by means of such manipulations, braking/driving (in other words, acceleration/deceleration) and steering of the vehicle C can be controlled. More specifically, the drive mechanism 28, the steering mechanism 30, and the braking mechanism 32 receive transmission of an acceleration control command upon forward tilt of the manipulation lever 33, a deceleration control command upon rearward tilt of the manipulation lever 33, and a control command for turning in the tilted direction upon rightward or leftward tilt of the manipulation lever 33. The manipulation lever 33 is manipulated by the administrator 105 (see FIG. 1) during manual driving.

The control unit 20 may for example be an electronic control unit (ECU) of the vehicle C, and is constituted of a computer. The control unit 20 shown as an example in FIG. 2 comprises an input/output controller 20A that controls data input and output. The control unit 20 further comprises, as computing elements, a CPU 20B, a GPU 20C (graphic processing unit), and a DLA 20D (deep learning accelerator). The control unit 20 also comprises, as storage devices, a ROM 20E, a RAM 20F, and a hard disk drive 20G (HDD). These constituent components are connected to an internal bus 20J.

In addition, the control unit 20 includes an input unit 20H and a display unit 20I as a user interface for the on-board administrator. The input unit 20H and the display unit 20I may be a touchscreen, for example.

FIG. 3 shows example functional blocks of the control unit 20. The functional blocks are configured including a scan data analyzer 40, a self-location estimator 42, a path creator 44, an autonomous travel controller 46, an operation schedule modifier 50, a drive mode switching controller 52, and a manual driving controller 54. The control unit 20 further comprises, as storage devices, a dynamic map storage section 48 and an operation schedule storage section 49.

The dynamic map storage section 48 has stored therein dynamic map data of the circulation route 100 and its surroundings. The dynamic map is a three-dimensional map, and includes, for example, information on locations and shapes (three-dimensional shapes) of roads (roadways and sidewalks). Information on locations of lane markings, crosswalks, stop lines, etc., drawn on roads are also included in the dynamic map. The dynamic map additionally contains information on locations and shapes (three-dimensional shapes) of built structures such as buildings and vehicle traffic lights. The dynamic map data are supplied from the operation management device 10.

The operation schedule storage section 49 has stored therein an operation schedule for the vehicle C in which the storage section 49 is provided. As mentioned above, this operation schedule is updated every cycle at the operation schedule updating point Pu (see FIG. 1).

The vehicle C performs autonomous travel in accordance with data regarding the circulation route 100 stored in the dynamic map storage section 48. In performing the autonomous travel, three-dimensional point cloud data regarding the surroundings of the vehicle C are acquired by the LiDAR unit 23. Further, the camera 22 captures images of the surroundings of the vehicle C.

Objects in the captured images captured by the camera 22 are analyzed by the scan data analyzer 40. For example, objects within the captured images are detected by a known deep learning method such as SSD (Single Shot Multibox Detector) or YOLO (You Only Look Once) using supervised learning, and subsequently, attributes of the detected objects (station ST, pedestrian, built structure, etc.) are recognized.

Further, the scan data analyzer 40 obtains the three-dimensional point cloud data (LiDAR data) from the LiDAR unit 23. By superimposing the captured images of the camera 22 and the LiDAR data, an object's attribute (station ST, pedestrian, construction, etc.) and distance from the vehicle C can be determined.

The self-location estimator 42 estimates the self-location of the vehicle C within the dynamic map based on the location (latitude and longitude) of the vehicle C received from the GPS receiver 26. The estimated self-location is used for path creation, and is also transmitted to the operation management device 10 together with time information obtained from the clock 27.

The path creator 44 creates a path from the estimated self-location to the nearest target site. For example, a path from the estimated self-location to a station ST is created. When it is determined from the three-dimensional point cloud data of the LiDAR unit 23 and the captured images of the camera 22 that there is an obstacle in a direct path from the estimated self-location to the station ST, a path avoiding the obstacle is created.

The autonomous travel controller 46 executes an autonomous travel control of the vehicle C based on the superimposed data of the captured images and the LiDAR data, the self-location, the created path, and the operation schedule, which are obtained as described above. For example, a travel velocity along the created path is autonomously controlled so as to match a target velocity V0 (described further below) set by the normal operation schedule. For example, the autonomous travel controller 46 controls the drive mechanism 28 comprising an inverter or the like, and thereby maintains the velocity of the vehicle C to the target velocity V0. Further, the autonomous travel controller 46 manipulates wheels 31 via control of the steering mechanism 30 comprising an actuator or the like, and thereby controls the vehicle C to travel along a decided path.

At the station ST, the autonomous travel controller 46 causes the vehicle C to stop and then causes a boarding/alighting door (not shown) to open. At that point, the autonomous travel controller 46 refers to the clock 27, and maintains the vehicle C in the stopped state until the target departure time Td* (described further below) set by the operation schedule is reached. After completion of boarding and alighting, when the target departure time Td* is reached, the autonomous travel controller 46 causes the boarding/alighting door to close and causes the vehicle C to depart.

When the vehicle C receives an operation interruption command issued from a command unit 61 of the operation management device 10, the autonomous travel controller 46 executes an emergency stop control for stopping the vehicle C.

The drive mode switching controller 52 can switch the manner of travel of the vehicle C between autonomous travel driving and manual driving. As described further below, after the operation interruption command is received from the operation management device 10 and the emergency stop control is executed by the autonomous travel controller 46, the drive mode switching controller 52 switches the drive control of the vehicle C from autonomous travel driving to manual driving. As a result, an evacuating drive for moving the vehicle C to an evacuation destination station ST is carried out by manual driving. As described further below, this switching is performed in response to input of a confirming command by the administrator 105 via the input unit 20H.

When the drive method of the vehicle C is switched from autonomous travel driving to manual driving, the manual driving controller 54 controls the drive mechanism 28, the steering mechanism 30, and the braking mechanism 32 in accordance with manipulation of the manipulation lever 33 by the administrator.

Upon receiving an operation restart command from the operation management device 10, the operation schedule modifier 50 modifies and shortens the normal operation schedule stored in the operation schedule storage section 49. Details in this regard are given further below.

### <Configuration of Operation Management Device>

The operation management device 10 manages operation of the vehicles C that travel autonomously along the circulation route 100. The operation management device 10 is installed in, for example, a management company that manages operation of the vehicles C. The operation management device 10 may be constituted of a computer, and FIG. 2 illustrates an example hardware configuration of the operation management device 10.

Similar to the hardware configuration of the vehicle C, the operation management device 10 comprises an input/output controller 10A, a CPU 10B, a GPU 10C, a DLA 10D, a ROM 10E, a RAM 10F, and a hard disk drive 10G (HDD). These constituent components are connected to an internal bus 10J.

The operation management device 10 further comprises an input unit 10H, such as a keyboard and a mouse, for inputting data as appropriate. The operation management device 10 also comprises a display unit 10I, such as a display, for displaying an operation schedule and the like for viewing. The input unit 10H and the display unit 10I are connected to the internal bus 10J.

FIG. 3 shows example functional blocks of the operation management device 10. The operation management device 10 includes, as storage devices, an operation schedule storage section 65 and a dynamic map storage section 66. The operation management device 10 further includes, as functional units, a vehicle information acquiring unit 60, the command unit 61, an operation schedule creator 62, an operation schedule supplier 63, and an operation route creator 64.

The operation route creator 64 creates a route along which the vehicles C are to travel; i.e., the circulation route 100. The circulation route 100 is created by selecting a route from roads such as those that include branches. Dynamic map data corresponding to the created circulation route 100 are extracted from the dynamic map storage section 66 and transmitted to the vehicles C.

The operation schedule creator 62 creates operation schedules to be provided to the plurality of operating vehicles C along the circulation route 100. As described further below, the operation schedule creator 62 is able to create a normal operation schedule and a recovering operation schedule. Further, based on a created operation schedule and time information obtained from the clock 17, the operation schedule creator 62 can calculate a target arrival time Ta* and a target departure time Td* at each of the stations ST1-ST3, as described below. Here, although the clock 17 in FIG. 2 is provided outside the operation management device 10, the clock 17 may alternatively be incorporated in the operation management device 10.

The operation schedule supplier 63 supplies an operation schedule created by the operation schedule creator 62 to each operating vehicle C at the operation schedule updating point Pu (operation schedule updating site). As mentioned above, the operation schedule supplier 63 supplies an operation schedule for one cycle of the circulation route 100 to each operating vehicle C passing the operation schedule updating point Pu.

The vehicle information acquiring unit 60 receives vehicle information from each vehicle C. The vehicle information includes the current location, the number of persons on board, the SOC of the battery, information on various devices acquired by vehicle-mounted sensors, and so on.

The command unit 61 is capable of issuing, to the operating vehicles C, an operation interruption command and a restart command instructing restart of operation. The operation interruption command is issued when, for example, there is a disorder in the operation management device 10 or when a VIP is scheduled to pass by. When the operation management device 10 is restored, or when the passing of the VIP is over, the restart command is issued.

### <Operation Schedule>

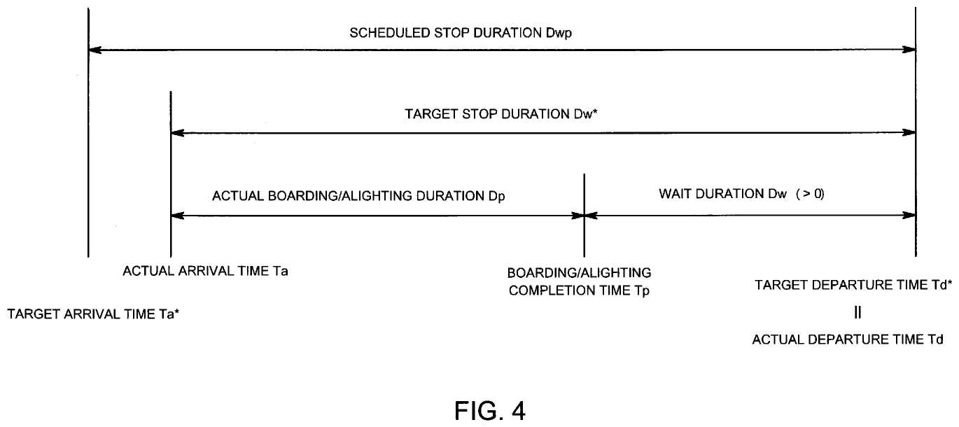

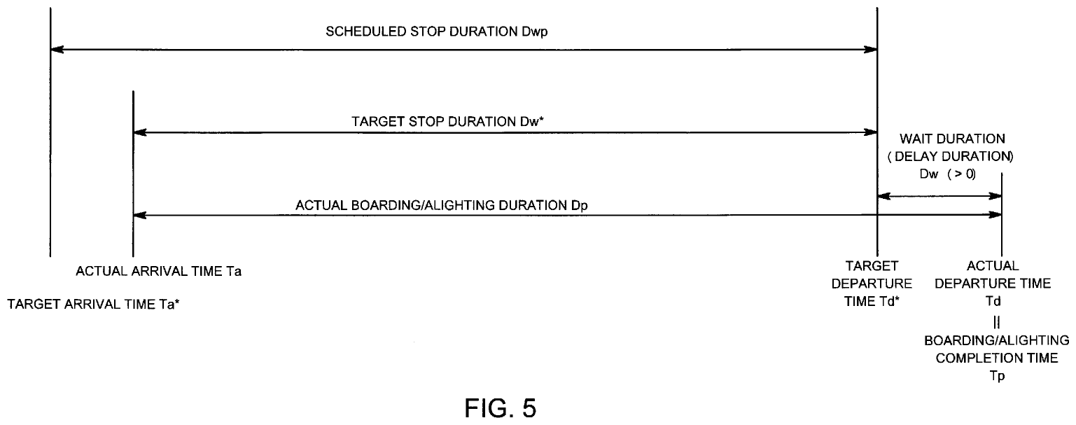

Terms used in connection with operation schedules and in connection with making modifications to the schedules are illustrated in FIGS. 4 and 5. As can be seen in FIG. 4, in a normal operation schedule, a target arrival time Ta* at each station ST and a target departure time Td* for departing from the station are set for each vehicle C. The duration from the target arrival time Ta* to the target departure time Td* corresponds to the stop duration of the vehicle C according to the schedule, and is referred to as a scheduled stop duration Dwp.

During actual operation, there are cases in which a vehicle C arrives at a station ST at a time different from the target arrival time Ta* due to reasons such as a delay generated at a previous station and a traffic congestion on the circulation route 100. This actual arrival time is referred to as actual arrival time Ta. Further, a duration from the actual arrival time Ta to the target departure time Td* is the target duration to be observed in order to cause the vehicle C to depart from the station ST on schedule, and is referred to as the target stop duration Dw*.

An actual duration of boarding and alighting with respect to the vehicle C is called actual boarding/alighting duration Dp. The actual boarding/alighting duration Dp is the duration from the actual arrival time Ta to the boarding/alighting completion time Tp. The duration obtained by subtracting the actual boarding/alighting duration Dp from the target stop duration Dw* is referred to as the wait duration Dw.

FIG. 4 shows an example case in which the wait duration Dw has a positive value. In this case, the wait duration Dw is the duration from the boarding/alighting completion time Tp to the target departure time Td*, and is the period of waiting until departure after completion of boarding and alighting with respect to the vehicle C. After elapse of the wait duration Dw, when the target departure time Td* is reached, the vehicle C departs from the station. In other words, when the wait duration Dw has a positive value, the actual departure time Td at which the vehicle C actually departs from the station ST basically matches the target departure time Td*.

FIG. 5 shows an example case in which the actual boarding/alighting duration Dp exceeds the target stop duration Dw* so that the wait duration Dw has a negative value; i.e., a case in which the wait duration Dw is indicated as the delay duration Dw. In this case, boarding and alighting of passengers continue even after the target departure time Td*, and the vehicle C departs immediately after completion of the boarding and alighting, so that the boarding/alighting completion time Tp basically matches the actual departure time Td.

### <Normal Operation Schedule>

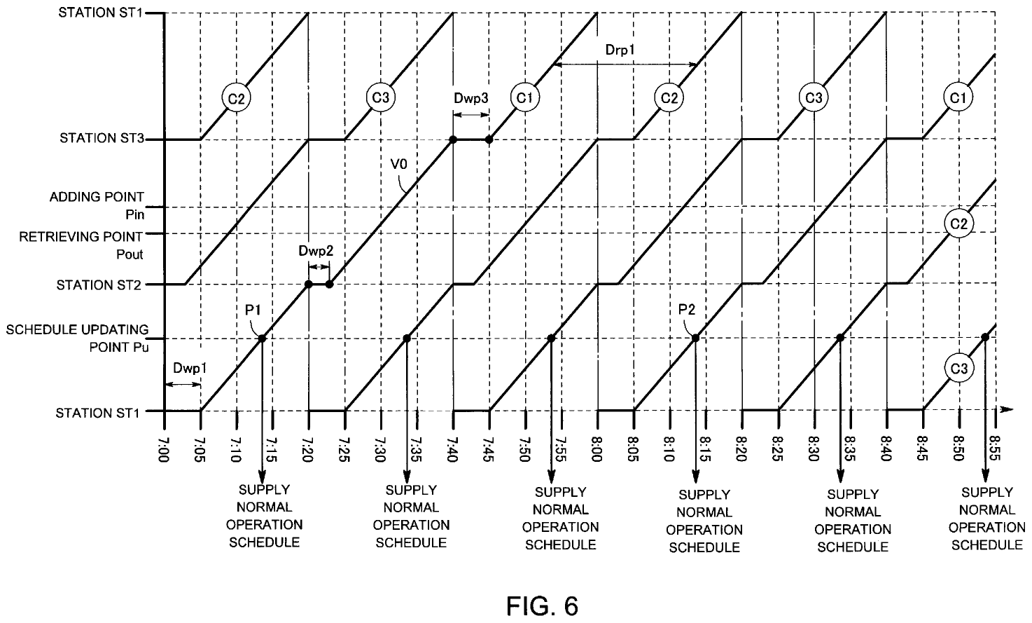

FIG. 6 shows an example timetable graph according to a normal operation schedule. In the timetable graph, time is given on the horizontal axis, while the vertical axis is used to indicate the respective sites on the circulation route 100; namely, the stations ST1-ST3, the operation schedule updating point Pu, the retrieving point Pout, and the adding point Pin. A normal operation schedule such as the one shown is created by the operation schedule creator 62.

In FIG. 6, a normal operation schedule in which three vehicles C1-C3 are operated at intervals of 20 minutes is organized. “Normal operation schedule” denotes an operation schedule to be applied when vehicles C that perform autonomous travel along the circulation route 100 (corresponding to the vehicles C1-C3 in FIG. 6) are caused to travel in a cycle while maintaining the same number of vehicles. In other words, when each of the vehicles C is to travel for one cycle on the circulation route 100 without any increase or decrease in the number of vehicles, a normal operation schedule is applied.

In the example normal operation schedule, in order that the operation intervals between the vehicles C traveling along the circulation route 100 become uniform, the scheduled stop durations Dwp1, Dwp2, Dwp3 at the respective stations ST1-ST3 are set uniformly for the respective vehicles C. The target velocity V0 is also set uniformly for the respective vehicles C.

The target velocity V0 and the scheduled stop durations Dwp1, Dwp2, Dwp3 at the respective stations ST1-ST3, which are set in the normal operation schedule, are also referred to as “normal values” when appropriate. From this perspective, it can be said that a normal operation schedule is an operation schedule that is organized using normal values. A normal operation schedule is set by the operation schedule creator 62 of the operation management device 10 in advance, for example, before actually carrying out an operation according to the operation schedule.

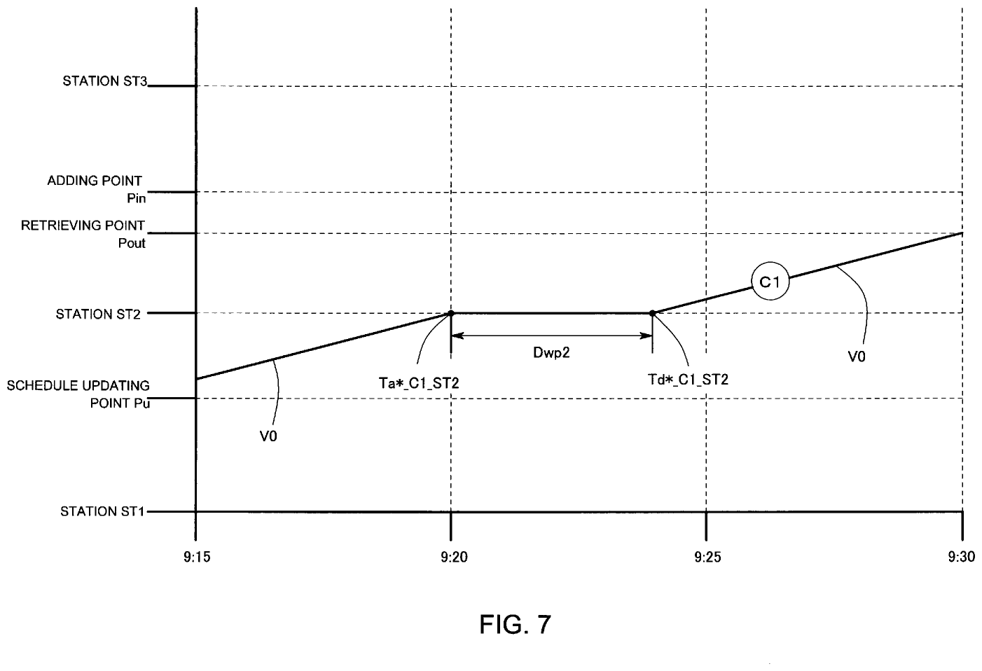

Based on the target velocity V0 and the scheduled stop durations Dwp1, Dwp2, Dwp3, times at which each vehicle C passes the respective sites on the circulation route 100 are calculated. For example, a time of passage of the operation schedule updating point Pu can be obtained from the clock 17 (see FIG. 2). For the operating vehicle C1 caused to travel at the target velocity V0 from the operation schedule updating point Pu, the target arrival time at the station ST2 (target arrival time Ta*_C1_ST2) is calculated as shown for example in FIG. 7. Further, the target departure time at the station ST2 (target departure time Td*_C1_ST2) is calculated, which occurs after the operating vehicle C1 is caused to stop at this site for the scheduled stop duration Dwp2. In this way, the target arrival time and the target departure time at each station ST are calculated. Furthermore, based on the target velocity V0, the path distance along the circulation route 100, and the scheduled stop durations Dwp1, Dwp2, Dwp3, the target time of passage of the operation schedule updating point Pu is calculated.

At the operation schedule updating point Pu (operation schedule updating site), the operation schedule supplier 63 (FIG. 3) supplies a normal operation schedule or a recovering operation schedule (described further below) to the vehicles C1-C3 passing that point. At that time, to the vehicles C1-C3 passing the operation schedule updating point Pu, the operation schedule supplier 63 supplies either one of the above-noted operation schedules for one cycle.

For example, when the operating vehicle C1 is passing the operation schedule updating point Pu, data of an operation schedule for the operating vehicle C1 from this point Pu until the next passage of the operation schedule updating point Pu (e.g., from point P1 to point P2 in FIG. 6) is supplied to the operating vehicle C1.

The operation schedule data to be supplied to the operating vehicle Ck (in a three-vehicle operation, k=1-3) at that time include the target arrival times Ta*_Ck_ST1˜Ta*_Ck_ST3 at the respective stations ST1-ST3, and the target departure times Td*_Ck_ST1˜Td*_Ck_ST3 at the respective stations ST1-ST3. Further, the scheduled stop durations Dwp1, Dwp2, Dwp3 at the respective stations ST1-ST3 and the target velocity V0 are also included in the operation schedule data to be supplied to the operating vehicle Ck.

### <Operation Management at the Time of Operation Interruption and Restart>

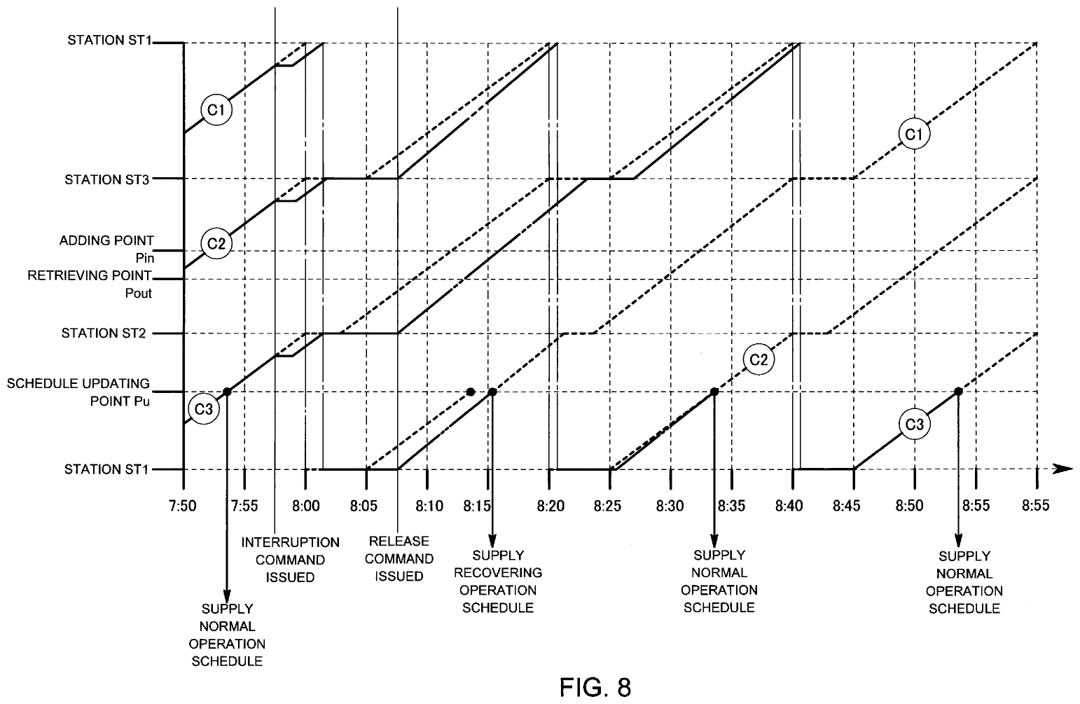

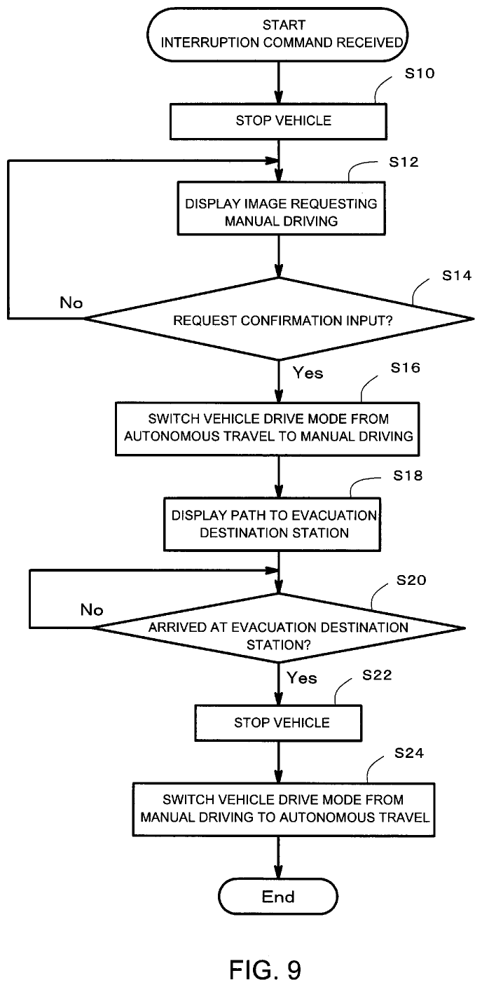

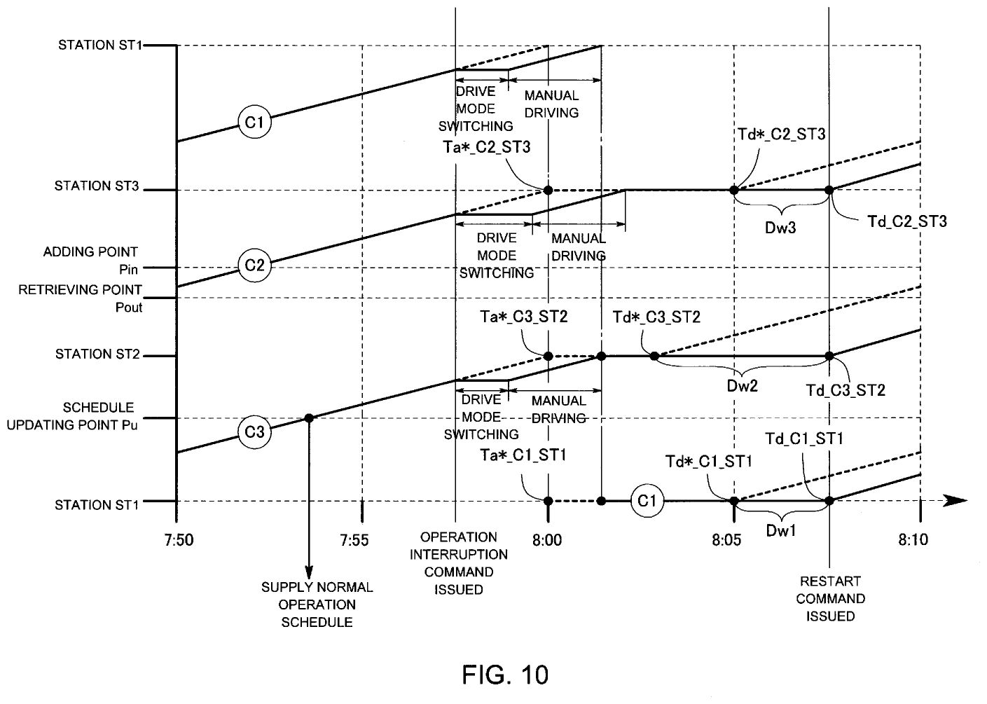

FIG. 8 shows an example timetable graph for a case of operation interruption and restart of the operating vehicles C. FIG. 9 shows an example flowchart illustrating an evacuation control performed when an operation interruption command has been issued to the vehicles C from the command unit 61 of the operation management device 10. This flowchart is executed by the control unit 20 (see FIG. 3) of each vehicle C. Further, FIG. 10 shows an example timetable graph mainly illustrating a period from issuance of the operation interruption command to issuance of the restart command.

Upon receiving the operation interruption command issued by the command unit 61 (at around 7:57 in FIG. 10), the autonomous travel controller 46 of each vehicle C executes an emergency stop control (S10). For example, the autonomous travel controller 46 manipulates the braking mechanism 32 and thereby causes the vehicle C to make an emergency stop. Subsequently, the drive mode switching controller 52 causes the display unit 20I to display an image that requests manual driving (S12). The drive mode switching controller 52 determines whether or not a confirming command in response to the manual driving request is input via the input unit 20H (S14). When the confirming command has not been input, the display unit 20I continues to display the manual driving requesting image.

The administrator 105 (see FIG. 1) aboard the vehicle C sees the manual driving requesting image, and inputs a confirming command in response thereto via the input unit 20H. The confirming command is recognized as a command to execute manual driving. In response to the input of the confirming command, the drive mode switching controller 52 switches the drive mode of the vehicle C from autonomous travel driving by the autonomous travel controller 46 to manual driving carried out via manipulation of the manipulation lever 33 by the administrator 105 (S16).

By means of manual driving, the vehicle C is moved to an evacuation destination station. The evacuation destination station is, for example, the nearest station ST located along the forward travel direction of the vehicle C. In the example of FIG. 10, the vehicle C1 moves to the evacuation destination station ST1, the vehicle C2 moves to the evacuation destination station ST3, and the vehicle C3 moves to the evacuation destination station ST2, respectively.

In carrying out this manual driving, the display unit 20I displays a path from the current location to the evacuation destination station ST (S18). The administrator 105 manipulates the manipulation lever 33 in accordance with the path display, and the manual driving controller 54 controls the drive mechanism 28, the steering mechanism 30, and the braking mechanism 32 in response to the manipulation of the manipulation lever 33.

The manual driving controller 54 determines whether or not the vehicle C has arrived at the evacuation destination station ST (S20). When the vehicle C arrives at the evacuation destination station ST by manual driving, the manual driving controller 54 causes the vehicle C to be stopped (S22). Subsequently, the manual driving controller 54 switches the drive mode of the vehicle C from manual driving carried out via manipulation of the manipulation lever 33 by the administrator 105 to autonomous travel driving by the autonomous travel controller 46 (S24). The autonomous travel controller 46 maintains the stopped state of the vehicle C until a restart command is received. Further, at that time, the autonomous travel controller 46 causes the boarding/alighting door (not shown) to open. By doing so, boarding and alighting with respect to the vehicle C are enabled during the interruption duration.

In this way, a part of the operation interruption duration is absorbed into the boarding/alighting duration at the station. In other words, by incorporating a part of the interruption duration in the stop duration of the vehicle C, the delay duration can be shortened as compared to a case in which, for example, the vehicle C is made to wait on a road between stations during the operation interruption duration.

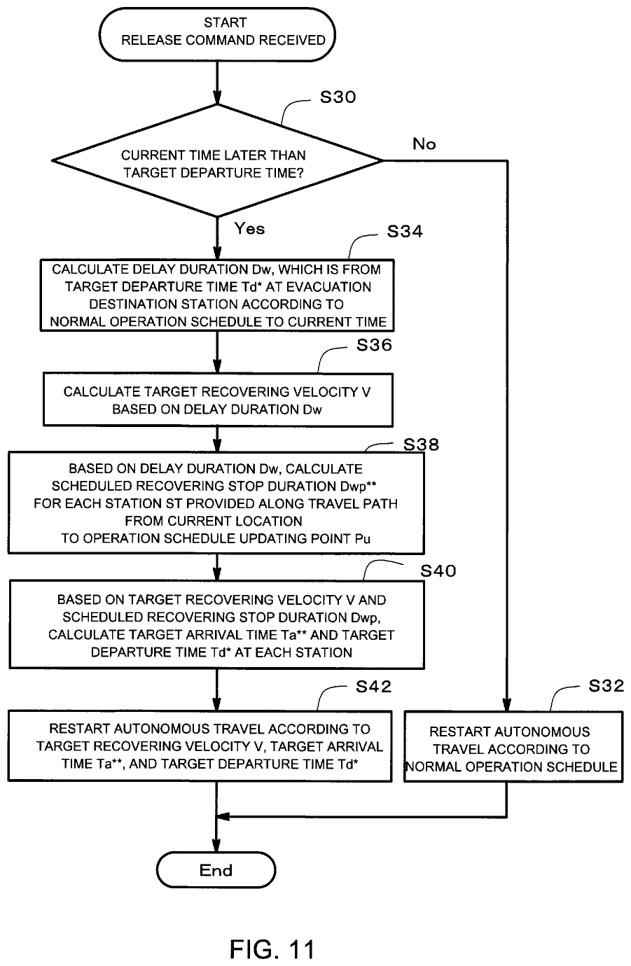

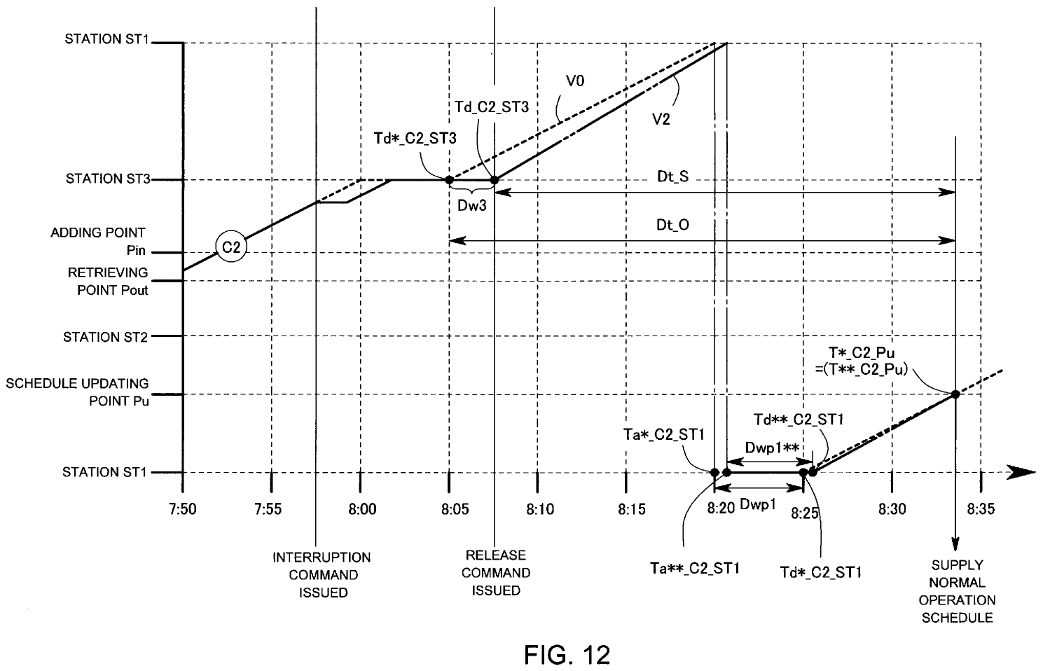

FIG. 11 shows an example flowchart illustrating a recovering control performed after receipt of the restart command. In FIG. 11, the suffixes to be added to the respective parameters according to the individual vehicles C and stations ST are not indicated. FIG. 12 illustrates a timetable graph for the vehicle C2, in double-dot-dashed lines, according to an operation schedule that has been modified and shortened by a recovering control. While an explanation is given below regarding the vehicle C2, a similar control is executed also for the vehicles C1, C3.

When conditions for restart of operation are met, the restart command (operation restart command) is issued from the command unit 61 of the operation management device 10. The operation schedule modifier 50 of the vehicle C2, which has received this command, determines whether or not the current time at which operation is restarted is later than target departure time Td*_C2_ST3 at the evacuation destination station ST3 set according to the normal operation schedule (S30).

When the current time is equal to or earlier than the target departure time Td*_C2_ST3, this indicates that the operation interruption duration entirely fell within the stop duration at the evacuation destination station ST3, and no delay is generated. Accordingly, the operation schedule modifier 50 makes no schedule modification. The autonomous travel controller 46 restarts operation of the vehicle C2 according to the normal operation schedule (S32).

On the other hand, when the current time (i.e., the restart time) is later than the target departure time Td*_C2_ST3 in step S30, the operation schedule modifier 50 modifies and shortens the normal operation schedule stored in the operation schedule storage section 49.

As illustrated in FIG. 12 for example, the operation schedule modifier 50 modifies the normal operation schedule so that the travel duration for traveling from the evacuation destination station ST3 to the operation schedule updating point Pu is made shorter than the corresponding travel duration Dt_O according to the normal operation schedule and is thereby set to travel duration Dt_S.

In making this modification for shorter duration, the operation schedule modifier 50 calculates delay duration Dw3, which is from the target departure time Td*_C2_ST3 at the evacuation destination station ST3 according to the normal operation schedule to the current time (i.e., the restart time) (S34).

Further, the operation schedule modifier 50 calculates target recovering velocity V (where V>V0) based on the calculated delay duration Dw3 (S36). In FIG. 12, the target recovering velocity for the vehicle C2 is denoted as velocity V2. For example, in the qualitative respect, the delay duration Dw and the target recovering velocity V have a directly proportional relationship, and the target recovering velocity V is set to a higher velocity when the delay duration Dw is longer.

For example, a coefficient K (where K>1.0) to be applied to the target velocity V0 is determined in accordance with the delay duration Dw3, and the target recovering velocity V2 (see FIG. 12) is calculated by V0×K=V2. In order to avoid excessively high velocities, an upper limit value may be set for the target recovering velocity V2. Subsequently, the operation schedule modifier 50 calculates, based on the calculated delay duration Dw3, a scheduled recovering stop duration Dwp** (where Dwp**<Dwp) at a station ST where the vehicle is scheduled to stop by while traveling from the current location to the operation schedule updating point Pu (S38). In FIG. 12, scheduled recovering stop duration Dwp1** (where Dwp1**<Dwp1) at the station ST1 where the vehicle C2 is scheduled to stop by is calculated. For example, in the qualitative respect, the delay duration Dw and the scheduled recovering stop duration Dwp** have an inversely proportional relationship, and the scheduled recovering stop duration Dwp** is set to a shorter duration when the delay duration Dw is longer.

For example, a coefficient K (where K<1.0) to be applied to the scheduled stop duration Dwp1 is determined in accordance with the delay duration Dw3, and the scheduled recovering stop duration Dwp1** is calculated by Dwp1×K=Dwp1**.

Based on the calculated target recovering velocity V2, the scheduled recovering stop duration Dwp1**, and the current time (i.e., the restart time), the operation schedule modifier 50 calculates target arrival time Ta**_C2_ST1 and target departure time Td**_C2_ST1 at the station ST1 where the vehicle C2 is scheduled to stop by before arriving at the operation schedule updating point Pu (S40). Further, target time of passage T**_C2_Pu of the operation schedule updating point Pu is also calculated. In this way, an operation schedule obtained by modifying and shortening the normal operation schedule is created as shown in double-dot-dashed lines in FIG. 12. The autonomous travel controller 46 restarts autonomous travel of the vehicle C2 according to the modified and shortened operation schedule (S42).

### <Creation of Recovering Operation Schedule>

When the site at which operation is restarted is sufficiently away from the operation schedule updating point Pu, the delay can be eliminated by means of the operation based on the modified and shortened operation schedule. On the other hand, when operation is restarted at a location close to the operation schedule updating point Pu, there may be situations in which a vehicle arrives at the operation schedule updating point Pu without the delay being fully eliminated.

To address such situations, the operation schedule creator (FIG. 3) of the operation management device 10 creates a recovering operation schedule for a vehicle C whose time of passage of the operation schedule updating point Pu after the restart of operation is predicted to be delayed from the target time of passage according to the normal operation schedule. The recovering operation schedule is created such that its cycle travel duration is shortened in accordance with the delay duration, as compared to the normal operation schedule.

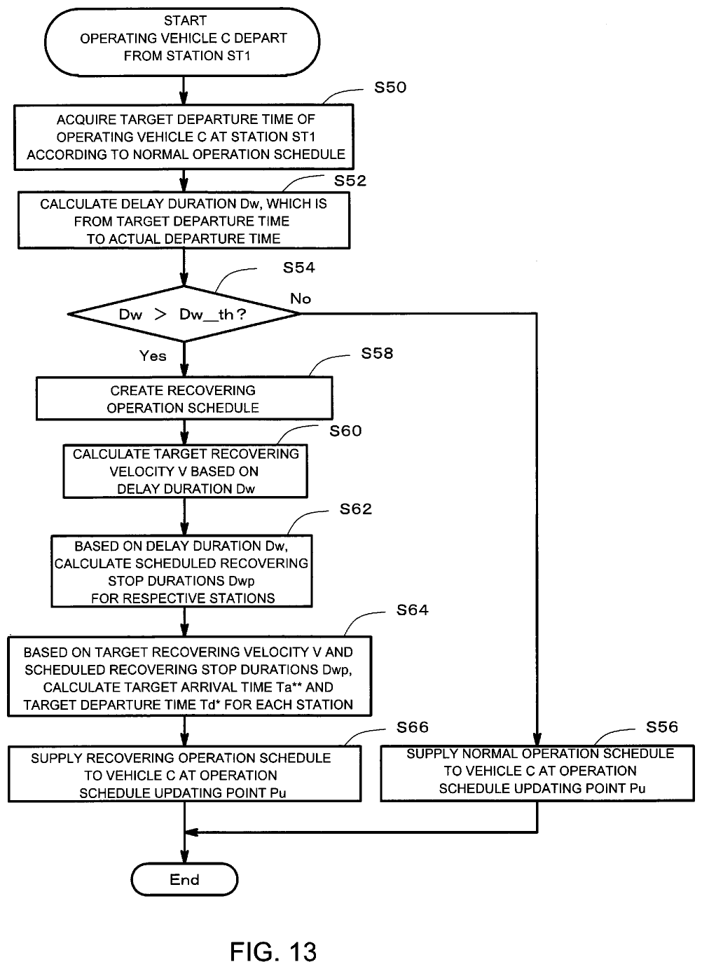

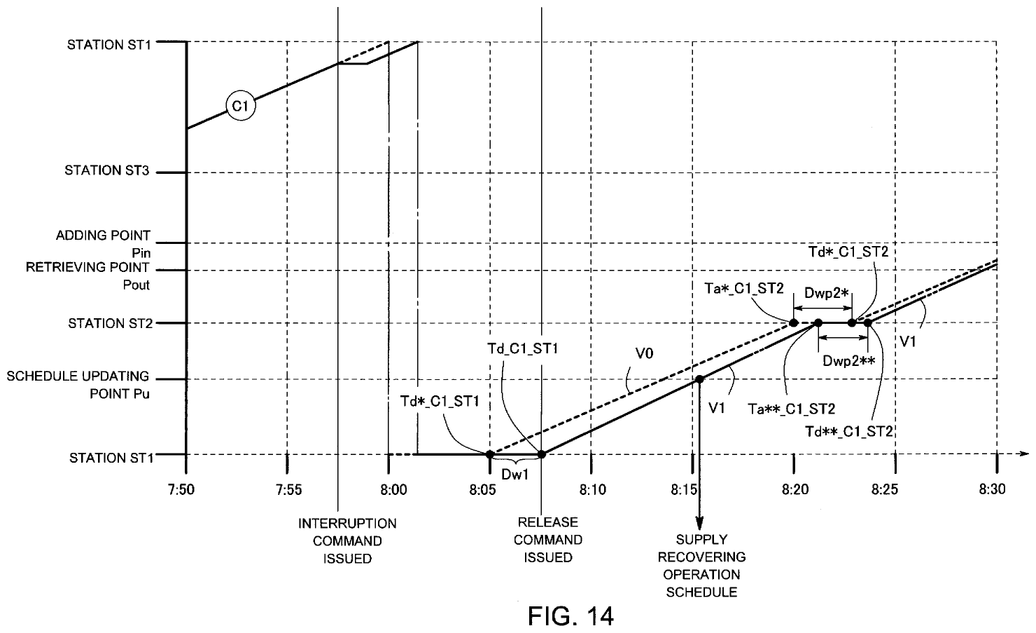

FIG. 13 shows an example process of creating a recovering operation schedule. In FIG. 13, the suffixes to be added to the respective parameters according to the individual vehicles C and stations ST are not indicated. FIG. 14 shows an example timetable graph that provides a recovering operation schedule for the vehicle C1. While an explanation is given below regarding the vehicle C1, a similar control is executed also for the vehicles C2, C3.

The operation schedule creator 62 acquires location information of the vehicle C1 on the circulation route 100. Further, after restart of operation, the operation schedule creator 62 detects the vehicle C1 that has departed from the station ST located upstream (relative to the forward travel direction of the vehicle C1) of and closest to the operation schedule updating point Pu (in FIG. 14, the station ST1).

Next, the operation schedule creator 62 obtains target departure time Td*_C1_ST1 of the detected vehicle C1 according to the normal operation schedule (S50). The operation schedule creator 62 further obtains actual departure time Td_C1_ST1 of the vehicle C1 that has departed from the station ST1. The operation schedule creator 62 then calculates delay duration Dw1, which is from the target departure time Td*_C1_ST1 to the actual departure time Td_C1_ST1 (S52).

Further, the operation schedule creator 62 determines whether or not the delay duration Dw1 exceeds threshold duration Dw_th1 (S54). The threshold duration Dw_th1 is a positive parameter for determining whether or not the delay duration Dw1 is, for example, a minor delay that can be generated during normal operation.

When the delay duration Dw1 is less than or equal to the threshold duration Dw_th1, the operation schedule creator 62 creates a normal operation schedule, and supplies the normal operation schedule for one cycle to the vehicle C1 passing the operation schedule updating point Pu (schedule updating site) (S56).

On the other hand, when the delay duration Dw1 exceeds the threshold duration Dw_th1, the operation schedule creator 62 predicts that the time that the vehicle C1 operating with the delay duration Dw1 passes the operation schedule updating point Pu will be delayed from the target time of passage according to the normal operation schedule. Further, the operation schedule creator 62 creates a recovering operation schedule, in place of the normal operation schedule, as an operation schedule to be supplied to the vehicle C1 (S58).

Specifically, the operation schedule creator 62 calculates target recovering velocity V1 (where V1>V0) based on the delay duration Dw1 (S60). For example, in the qualitative respect, the delay duration Dw and the target recovering velocity V have a directly proportional relationship, and the target recovering velocity V is set to a higher velocity when the delay duration Dw is longer.

For example, a coefficient K (where K>1.0) to be applied to the target velocity V0 is determined in accordance with the delay duration Dw1, and the target recovering velocity V1 is calculated by V0×K=V1. In order to avoid excessively high velocities, an upper limit value may be set for the target velocity V1.

Subsequently, the operation schedule creator 62 calculates, based on the delay duration Dw1, scheduled recovering stop durations Dwp1** (where Dwp1**<Dwp1), Dwp2** (where Dwp2**<Dwp2), and Dwp3** (where Dwp3**<Dwp3) at the respective stations ST1-ST3 on the circulation route 100 (S62). For example, in the qualitative respect, the delay duration Dw and the scheduled recovering stop duration Dwp** have an inversely proportional relationship, and the scheduled recovering stop duration Dwp** is set to a shorter duration when the delay duration Dw is longer.

For example, a coefficient K (where K<1.0) to be applied to the scheduled stop duration Dwp1 is determined in accordance with the delay duration Dw1, and the scheduled recovering stop duration Dwp1** is calculated by Dwp1×K=Dwp1**.

Based on the calculated target recovering velocity V1, the scheduled recovering stop durations Dwp1**-Dwp3**, and the actual departure time Td_C1_ST1 at which the vehicle C1 departed from the station ST1, the operation schedule creator 62 calculates target arrival times Ta**_C1_ST1-Ta**_C1_ST3 and target departure times Td**_C1_ST1-Td**_C1_ST3 at the respective stations ST1-ST3 (S64). Further, target time of passage T**_C1_Pu of the operation schedule updating point Pu is also calculated.

In this way, the recovering operation schedule which is shortened as compared to the normal operation schedule is created as shown in double-dot-dashed lines in FIG. 14. The recovering operation schedule is supplied to the vehicle C1 when the vehicle C1 passes the operation schedule updating point Pu (S66). The autonomous travel controller 46 executes autonomous travel control of the vehicle C1 according to the supplied schedule.

### <Alternative Embodiment of Evacuating Drive>

In the example illustrated in FIG. 9, after receiving the operation interruption command, movement of the vehicle C to the evacuation destination station is carried out by manual driving. However, autonomous travel vehicles according to the present disclosure are not limited to this configuration. For example, after receiving the operation interruption command, movement of the vehicle C to the evacuation destination station may be carried out by autonomous travel driving.

For example, after receiving the operation interruption command, the autonomous travel controller 46 obtains a path from the current location to the evacuation destination station, which path has been created by the path creator 44. The evacuation destination station may be, for example, the nearest station located along the forward travel direction. Further, the autonomous travel controller 46 causes the vehicle C to travel along the obtained path to the evacuation destination station by autonomous travel driving. At that time, a display (not shown) provided on an outer face of the vehicle C may be used to convey to the surrounding area that the vehicle C is in the course of performing an evacuating drive.

When the vehicle C arrives at the evacuation destination station ST, the autonomous travel controller 46 causes the vehicle C to stop and to maintain the stopped state until a restart command is received. Further, at that time, the autonomous travel controller 46 causes the boarding/alighting door (not shown) to open. By doing so, boarding and alighting with respect to the vehicle C are enabled during the interruption duration.

The present disclosure is not limited to the embodiments described above, and includes all changes and modifications without departing from the technical scope or the essence of the present disclosure defined by the claims.

1. An autonomous travel vehicle that travels in a circulation route along which a plurality of stations are provided, comprising:
an operation schedule storage section having stored therein an operation schedule for one cycle of the circulation route, the operation schedule having been supplied at an operation schedule updating site set up along the circulation route;
an autonomous travel controller that carries out an autonomous travel control based on the operation schedule, and that executes an emergency stop control upon receipt of an operation interruption command; and
an operation schedule modifier configured such that, after an evacuating drive for moving the vehicle to an evacuation destination station is performed subsequent to the receipt of the operation interruption command, upon receiving an operation restart command while at the evacuation destination station, the operation schedule modifier executes a schedule modification so that, based on an actual operation delay duration with respect to the operation schedule, a travel duration for traveling from the evacuation destination station to the operation schedule updating site is shortened as compared to a corresponding travel duration according to the operation schedule.

2. The autonomous travel vehicle according to claim 1, further comprising:
a display unit that, upon receipt of the operation interruption command, displays to an on-board administrator an image requesting execution of manual driving;
an input unit via which a command for executing manual driving can be input; and
a drive mode switching controller that, when the command for executing manual driving is input, switches from autonomous travel driving by the autonomous travel controller to manual driving by the on-board administrator in carrying out the evacuating drive.

3. A traffic system comprising:
the autonomous travel vehicle according to claim 1; and
an operation management device for managing operation of the autonomous travel vehicle,
wherein the operation management device comprises:
an operation schedule creator that creates the operation schedule for the autonomous travel vehicle, the autonomous travel vehicle being provided in a plural number;
an operation schedule supplier that supplies the operation schedule for one cycle of the circulation route to each of the plurality of autonomous travel vehicles when the vehicle is passing the operation schedule updating site;
a command unit capable of issuing an operation interruption command and an operation restart command to the plurality of autonomous travel vehicles, wherein
the operation schedule creator creates, as the operation schedule, a normal operation schedule set such that operation intervals between the plurality of autonomous travel vehicles become uniform, and
for the autonomous travel vehicle whose time of passage of the operation schedule updating site subsequent to restart of operation is predicted to be delayed from a target time of passage according to the normal operation schedule, the operation schedule creator creates, as the operation schedule for a next cycle, a recovering operation schedule in which a cycle travel duration is shortened in accordance with a delay duration as compared to the normal operation schedule.
